(19) United States
(12) Patent Application Publication
(10) Pub. No.: US 2013/0307788 A1
(43) Pub. Date: Nov. 21, 2013

(54) DEVICE AND METHOD FOR AUTOMATED USE OF FORCE SENSING TOUCH PANELS

(71) Applicants: Raghunandan Nagaraja Rao, Bangalore (IN); Patrick B. Tilley, Coram, NY (US); Aroon V. Tungare, Winfield, IL (US); Yi Wei, Saint James, NY (US)

(72) Inventors: Raghunandan Nagaraja Rao, Bangalore (IN); Patrick B. Tilley, Coram, NY (US); Aroon V. Tungare, Winfield, IL (US); Yi Wei, Saint James, NY (US)

(73) Assignee: Motorola Solutions, Inc., Shaumburg, IL (US)

(21) Appl. No.: 13/473,273

(22) Filed: May 16, 2012

(51) Int. Cl. G06F 3/041

(52) U.S. Cl. 345/173

(57) ABSTRACT

A device and method determines a command from a touch input. The method includes determining an application-in-use data indicative of an application being executed. The method includes receiving, by a touch sensitive input device, a touch input data including at least one of a finger use input data, a force input data, a gesture input data, and a location input data. The finger use input data relates to how the touch input data is entered. The force input data relates to a pressure applied in the touch input data. The gesture input data relates to a motion of the touch input data over time. The location input data relates to a position on the input device. The method includes determining a command based on the application-in-use data and at least one of the finger use input data, the force input data, the gesture input data, and the location input data.

### FIELD OF THE DISCLOSURE

The present disclosure relates generally to a device and method for automated controls on a user interface of mobile devices using force sensing touch panels and more particularly to recognizing multi-touch inputs as a function of a finger use input, a location input, a force input, a gesture input, and an application-in-use input.

### BACKGROUND

An electronic device may incorporate a variety of different input technologies. For example, the electronic device may include a keypad to allow a user to enter inputs. In another example, the electronic device may include a touch sensor that enables a user to enter inputs. In yet another example, the electronic device may include a transparent touch sensor placed on top of a display that enables the user to enter inputs. Gesture recognition is gaining popularity in electronic devices. When properly utilized, gesture recognition enables faster and more intuitive commands. However, gesture recognition has intrinsic limitations associated therewith. Accurate gesture determination is one such limitation. Instead of a universally recognized language, there is no standard gestures library. More importantly, for a common gesture, different users perform the task differently. For example, with a left slide gesture, some users slide to the left first and then recoil back while other users prefer to move slightly to the right first then slide to the left. Numerous studies have been performed to increase accuracy by using different recognition algorithms such as hidden Markov models and Dynamic time warping methods without great success. A more straight forward method of overcoming this limitation is to limit the number of gestures performed to simple gestures in order to avoid confusion. However, this in turn limits the usefulness of the method itself

A typical touch sensor may utilize a wide variety of touch panel technologies which have multi-touch or force sensing capabilities. The force sensing mechanism of each touch panel may be varied. The electronic device utilizing the touch sensor may be configured with one of a wide variety of operating systems. With a plurality of fingers from the user, an innumerable number of single finger and multi finger gestures may be performed. Furthermore, depending on the various granularities of the pressure values sensed on the force sensing mechanism of the touch sensor, further combinations of finger gestures paired with pressure levels may be performed. In addition, a common gesture with a finger may be used with varying degrees of pressure being applied. While the above only relates to the use of a finger, the common gesture may also be performed using a stylus, a palm, etc., and the touch sensor may include even more possible touch sensor inputs having varying degrees of pressure. The method to determine the touch input may become very cumbersome, tedious, and inefficient for every developer or user to define these gestures and sense the pressure granularity and actions.

Accordingly, there is a need for a method and device for automated controls on a user interface of mobile devices using force sensing touch panels.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of the components of a mobile unit in accordance with some embodiments.

FIG. 2 is a gesture library for touch inputs in accordance with some embodiments.

FIG. 3 is a flowchart of a method for determining a command as a function of a touch input in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method and device for determining a command from a touch input. The method comprises determining an application-in-use data, the application-in-use data indicative of an application being executed by a processor on an electronic device; receiving, by a touch sensitive input device of the electronic device, a touch input data including at least a finger use input data, a force input data, a gesture input data, and a location input data, the finger use input data indicative of a manner in which the touch input data is entered, the force input data indicative of a pressure applied in how the touch input data is entered, the gesture input data indicative of a motion included in the touch input data over time, the location input data indicative of a position on the touch sensitive input device the touch input is received; and determining a command to be executed as a function of the application-in-use data and at least one of the finger use input data, the force input data, the gesture input data, and the location input data.

The exemplary embodiments may be further understood with reference to the following description and the appended drawings, wherein like elements are referred to with the same reference numerals. The exemplary embodiments describe an electronic device configured to determine a command as a function of a touch input. Specifically, the electronic device receives a touch input including at least a finger use input, a force input, a gesture input, and a location input that is used to determine a command for a particular application in use. The electronic device, the components thereof, the touch input including the finger use input, the force input, the gesture input, and the location input, the relation to the application in use, and a related method will be discussed in further detail below.

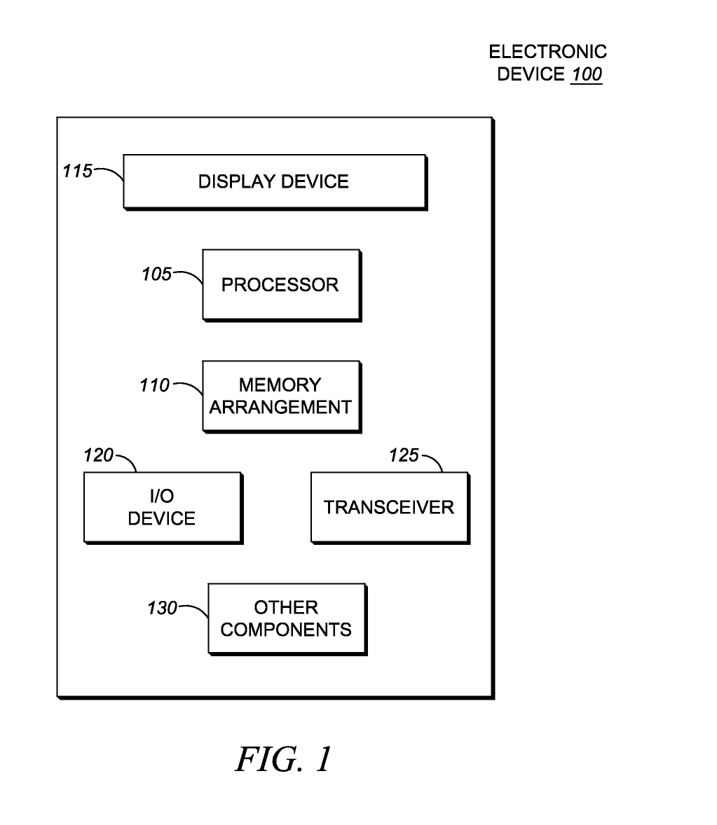

FIG. 1 is an electronic device 100 in accordance with an exemplary embodiment of the present invention. As illustrated, the electronic device 100 may be any portable device such as a mobile phone, a personal digital assistant, a smartphone, a tablet, a laptop, a barcode reader, etc. However, it should be noted that the electronic device 100 may represent any type of device that is capable of receiving a touch input that includes a finger use input, a force input, and a gesture input. Accordingly, the electronic device 100 may also represent a non-portable device such as a desktop computer. The electronic device 100 may include a variety of components. As illustrated in FIG. 1, the electronic device 100 may include a processor 105, a memory arrangement 110, a display device 115, an input/output (I/O) device 120, a transceiver 125, and other components 130 such as a portable power supply (e.g., a battery).

The processor 105 may provide conventional functionalities for the electronic device 100. For example, the MU 100 may include a plurality of applications that are executed on the processor 105 such as an application including a web browser when connected to a communication network via the transceiver 125. As will be discussed in further detail below, the processor 105 may also receive touch input data to determine a command to be executed. The memory 110 may also provide conventional functionalities for the electronic device 100. For example, the memory 110 may store data related to operations performed by the processor 105. As will be described in further detail below, the memory 110 may also store data related to touch inputs that further relate to a finger use input, a force input, a gesture input, and a location input in which these touch inputs are coordinated with an application in use to determine a command to be executed. Specifically, a gesture library may be stored in the memory 110. However, it should be noted that the gesture library may be stored in other locations such as a local memory of a microcontroller. The transceiver 125 may be any conventional component configured to transmit and/or receive data. The transceiver 125 may therefore enable communication with other electronic devices directly or indirectly through a network.

The display device 115 may be any component configured to show data to a user. The display device 115 may be, for example, a liquid crystal display (LCD) to conform to the size of the electronic device 100. The I/O device 120 may be any component configured to receive an input from the user. For example, the I/O device 120 may be a keypad (e.g., alphanumeric keypad, numeric keypad, etc.). The I/O device 120 may also be a touch sensing pad for a user to enter inputs manually with a finger(s) or a stylus. It should be noted that the display device 115 may also incorporate the I/O device 120, particularly when the I/O device 120 is a touch sensing pad including an area in which the user may enter inputs. In another example, the I/O device 120 may be a transparent touch sensor placed on top of the display 115 that enables a user to enter inputs. The exemplary embodiments of the present invention will be described with reference to when the display device 115 incorporates the I/O device 120. Thus, when a touch input is received on the display device 115 and the I/O device 120, a number of granularities may be determined. As will be described in further detail below, the I/O device 120 may be configured with a force sensor to determine an amount of pressure being applied with the touch input data. It should be noted that the exemplary embodiments of the present invention may also be used for a separate I/O device 120 disposed on a separate area of a housing on the electronic device 100.

According to the exemplary embodiments, the electronic device 100 is configured to receive a touch input data via the I/O device 120. The touch input data may include several components that the processor 105 interprets to determine a corresponding command to be executed therefrom further as a function of a present application being run by the processor 105. As discussed above, the components of the touch input data may include a finger use input, a force input, a gesture input, and a location input. The finger use input may relate to a number of fingers that the user places on the I/O device 120 for the touch input data. The force input may relate to a pressure applied on the I/O device 120. The gesture input may relate to a motion of the touch input data over time such as an initial disposition and a final disposition with the relative movement therebetween. The location input may relate to a position on the I/O device 120 in which the touch input is received (e.g., top area of the I/O device 120, bottom area of the I/O device, etc.). It should be noted that the finger use input is only exemplary. According to the exemplary embodiments of the present invention, the I/O device 120 may be configured to receive a touch input data from a stylus. The force input, the gesture input, and the location input may further be incorporated with the use of the stylus. Thus, the description herein regarding the finger use input may also be applied to when the user utilizes a stylus to enter the touch input data. It should also be noted that the touch input may be any combination of types of input formats. For example, the user may enter a touch input using a finger(s), a stylus, a palm, or any combination thereof.

The electronic device 100 may be preprogrammed and/or manually programmed with a gesture library. That is, the gesture library may include defined touch inputs either by an administrator (e.g., software library developer), by the user of the electronic device 100, or a combination thereof such as including predefined touch inputs but allow for changes or additional touch inputs to be defined by the user.

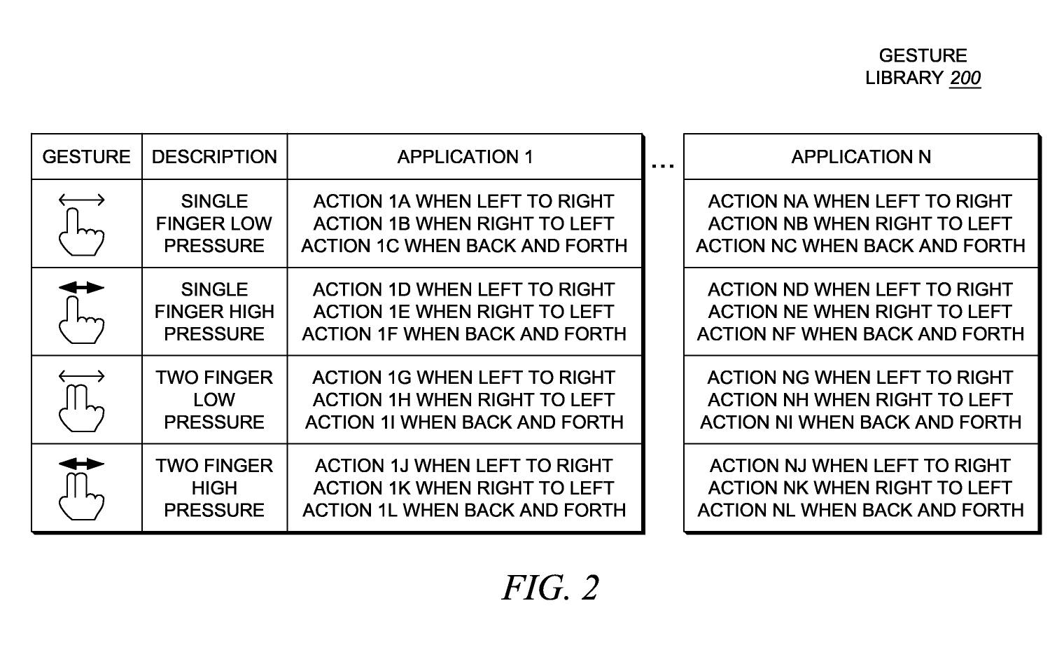

FIG. 2 shows a gesture library 200 for touch inputs according to some exemplary embodiments. As discussed above, the gesture library 200 includes several components used to define a command from the touch input data. An initial determination may be the finger use input. As illustrated in the gesture library 200, the finger use input may be between a single finger touch input or a two finger touch input. A subsequent determination may be the force input. The force input may be between a low pressure touch input or a high pressure touch input. A further determination may be the gesture input. The gesture input may be among a motion from left to right, a motion from right to left, and a back and forth motion. By determining the finger use input, the force input, and the gesture input, the gesture library 200 defines the command or action to be performed. Thus, as illustrated, when the finger use input is a single finger touch input, the force input is a low pressure touch input, and the gesture input is a motion from left to right, the gesture library 200 indicates that the command is an action 1A when the application 1 is running or an action NA when an application N is running In another example, when the finger use input is a two finger touch input, the force input is a high pressure touch input, and the gesture input is a back and forth motion, the gesture library 200 indicates that the command is an action 1L when the application 1 is running or an action NL when the application N is running

It should be noted that the finger use input being between a single finger and a two finger touch input is only exemplary. Those skilled in the art will understand that the gesture library 200 may further define the finger use input to include further types of finger use inputs. For example, as discussed above, the finger use input may relate to using a stylus. The I/O device 120 may be configured to determine granularities of the touch input. Therefore, when a single finger is used, a predetermined area of granularities that is substantially circular may indicate when a single finger touch input is being used. When more than one finger is used, predetermined areas of granularities present concurrently may indicate when a multi-finger touch input is being used. For example, an oblong, oval granularity having a substantially figure eight shape when the two fingers are together may indicate when the two finger touch input is being used. In another example, when two separate areas of granularities are detected, the two finger touch input may be determined. In yet another example, when three areas of granularities are detected, a three finger touch input may be determined. When a stylus is used, a predetermined area of granularities that is substantially circular and substantially less than a range of granularities of a single finger touch input may indicate when the stylus is being used. Those skilled in the art will understand that a point of stylus has a small contact area and a corresponding range of granularities present when using a stylus may also be small. In a further example, when two separate areas of granularities are detected in which a first area corresponds to a finger and a second area corresponds to a stylus, the combination touch input with a finger and a stylus may be determined

It should also be noted that the force input being a low or high pressure is only exemplary. Those skilled in the art will understand that the gesture library 200 may further define the force input to include further types of force inputs. For example, with a low pressure, a granularity count of a single finger touch input with a low pressure may have a substantially less range than a single finger touch input with a high pressure. That is, as the single finger is pushed harder onto the I/O device 120, the finger may depress to increase an area of contact between the finger and the I/O device 120. In a further example of different types of force inputs, the I/O device 120 may also be configured to determine force inputs that may be less than a low pressure input, greater than a high pressure input, or any type of force input in between the low and high pressure inputs. Accordingly, in a first exemplary embodiment of the present invention, the pressure of the force input may be determined as a function of the area of contact or granularity count between the finger and the I/O device 120. Therefore, a low pressure may have a first range of areas of contact which is less than a second range of areas of contact for a middle pressure which is less than a third range of areas of contact for a high pressure.

It should additionally be noted that the combined finger use input and the force input for multi-finger touch inputs having the same pressure is only exemplary. The exemplary embodiments of the present invention may also be configured to receive the touch input having multi-finger touch inputs in which different fingers provide different pressures. For example, in a two finger touch input, one finger may apply a low pressure while another finger may apply a high pressure. In this manner, the gesture library 200 may be configured to define a command to be performed for an application in use in a multi-modal manner in which multiple fingers may be used with different pressures being received.

It should further be noted that the gesture input being a motion from left to right, a motion from right to left, and a back and forth motion is only exemplary. Those skilled in the art will understand that the gesture library 200 may further define a plurality of different types of gesture inputs. Specifically, any motion of the touch input may be defined with the gesture library 200. For example, the application 1 may receive alphanumeric inputs so that a single finger touch input having a low pressure and a predefined gesture input may be for a specific letter or number such as a caret motion (i.e., angle upward motion followed by an angle downward motion) may be for a capital “A”. In another example, the gesture library 200 may include different forms of gesture inputs particularly when a multi-finger touch input is received. For example, with a two finger touch input, the two fingers may initially be disposed together and a separating of the fingers may be a type of gesture input. In another example, with a two finger touch input, the two fingers may initially be separated and subsequently drawn together for a further type of gesture input. In yet another example, the gesture library 200 may include a diagonal motion such as from a relative top right disposition to a relative bottom left disposition, vice versa, etc.

Those skilled in the art will understand that the gesture library 200 may be configured so that additional applications that are installed on the electronic device 100 may be included therein. As shown in the gesture library 200, there may be N different applications with each application having a predefined set of commands to be executed as a function of the finger use input, the force input, and the gesture input. When a further application (e.g., N+1) is installed on the electronic device, the gesture library 200 may be updated to store the commands that will be executed when a touch input is received for the N+1 application. Additional touch inputs may also be added or removed for an application already stored in the gesture library 200. For example, a single finger touch input having a high pressure with a back and forth motion for the application 1 may be removed. Thus, the action 1F may be removed. In another example, a two finger touch input having a low pressure with a finger separating motion for the application 1 may be added. Thus, an action 1M (not shown) may further be added to the gesture library 200 for the application 1. A software application module may be run for the gesture library 200. The software application module may include a list (i.e., library) of available finger use inputs, force inputs, and gesture inputs available for the user to define a command. For example, the user may define a new command with a finger use input, a force input, and a gesture input or may define an existing command to be executable with a further finger use input, a further force input, and a further gesture input.

It should further be noted that the gesture library 200 is only exemplary with regard to determining a command using only the finger use input, the force input, and the gesture input. As discussed above, the exemplary embodiments of the present invention may not require all three inputs when the application in use only requires one or two of the components of the touch input or may further require the location input to determine the command to be performed. Accordingly, the gesture library 200 may further define commands to be performed for applications as a function of the finger use input, the force input, the gesture input, the location input, and a combination thereof.

According to the exemplary embodiments of the present invention and evident from the above description, common gesture inputs may be associated with different commands. Specifically, the same gesture input may have different commands based on any combination of the force input, the finger use input, and the application to which the command is being entered. Accordingly, multi-modal operations may be achieved. In a specific example, a touch input data may be to move a single finger touch input (i.e., finger use input) with a light pressure (i.e., force input) over the I/O device 120 from right to left (i.e., gesture input) without losing contact while editing a word processing document (i.e., application in use input). This touch input data may be indicative of a strike through on the line or paragraph. If the same touch input data were received on a media player (i.e., application in use input), the touch input data may be indicative of a rewind functionality.

It should be noted that the exemplary embodiments of the present invention may be configured to tie the gesture library 200 to a developer's environment. That is, a region or object shown on the display 115 may be associated with one of the parameters of the touch input such as the force input. Thus, the application in use may define predetermined regions on the display 115 that may receive different types of touch inputs that may be mapped to different commands. For example, if the area on the display 115 is divided into quadrants, a top left area may receive a touch input corresponding to a first command while the top right area may also receive a touch input corresponding to a second command. However, according to this exemplary embodiment of the present invention, the touch input received on the top left area and the top right area may include the same parameters such as a common finger use input, a common force input, and a common gesture input. However, the gesture library 200 may define the command to be performed as a function of the quadrant. It should be noted that this definition may be a subset of the location input. In this way, a further manner of multi-modal input may be achieved. The display 115 may also be configured to aid the user in entering the proper touch input for a particular command by showing the parameters of the touch input that would activate the command. For example, an icon may appear on the display 115 with the specific parameters for the command.

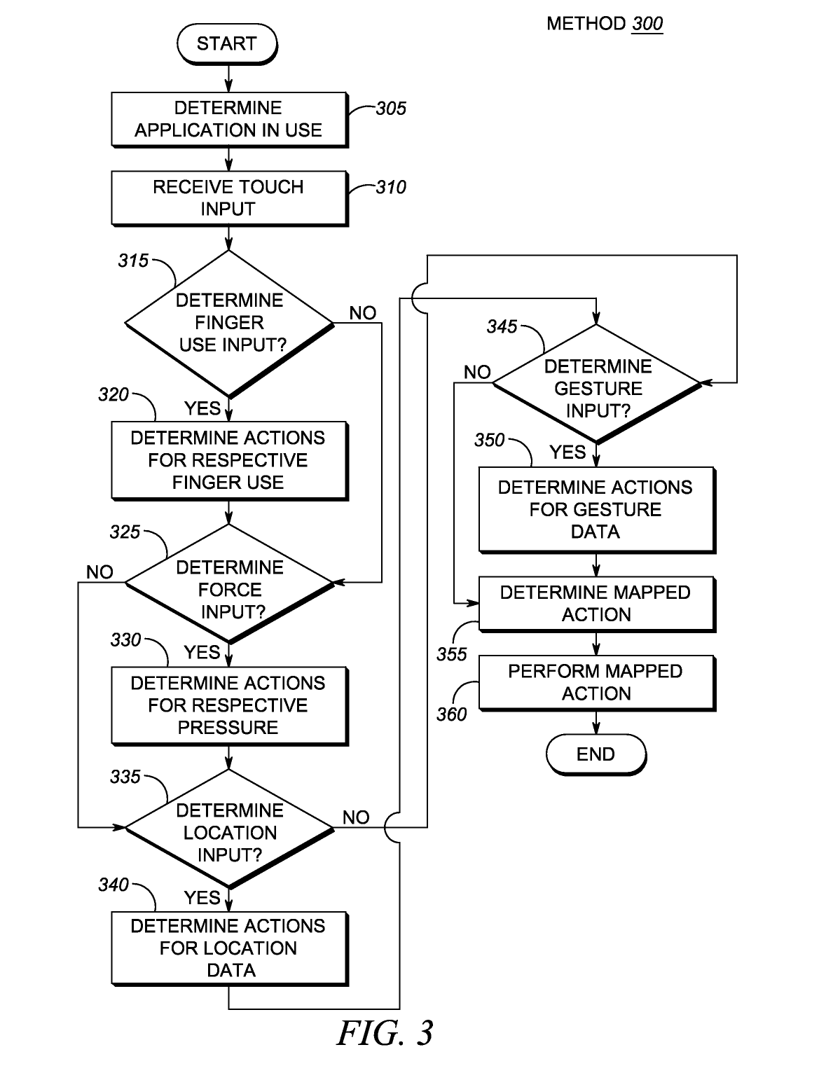

FIG. 3 is a flowchart of a method 300 for determining a command as a function of a touch input data including a finger use input, a force input, a gesture input, and a location input for an application in use in accordance with some embodiments. The method 300 relates to receiving the touch input data on the I/O device 120 of FIG. 1 and specifically to when the I/O device 120 is incorporated with the display device 115. The method 300 also relates to a gesture library such as the gesture library 200 of FIG. 2 which defines a command to be performed as a function of the finger use input including a finger touch input, a stylus touch input, a palm touch input, and a combination thereof; the force input including a low pressure, a medium pressure, a high pressure, and a combination thereof depending on the touch input; the gesture input including any type of gesture performed over time on the I/O device 120; and the location input including any position on the I/O device 120.

In step 305, the processor 105 determines an application in use. As discussed above, the command to be executed may be specific based upon the application in use and the touch input data. Accordingly, the processor 105 may initially make this determination. In a preferred exemplary embodiment of the present invention, the application in use may be determined first to simplify a mapping of the command on the gesture library. However, it should be noted that step 305 may be performed at the end of the method 300 after receiving and determining the touch input data as will described below. In this manner, the mapping of the touch input data may occur prior to a further mapping to the application in use. In step 310, the touch input data is received on the I/O device 120.

In step 315, the processor 105 determines whether the finger use input is to be determined. For example, the application in use may indicate that the finger use input is used or not used in the gesture library. If the finger use input is to be determined, the method 300 continues to step 320. In step 320, a number of fingers used for the touch input data is determined so that the actions for the respective finger use input are determined. Specifically, the processor 105 determines the finger use input associated with the touch input data. As discussed above, the I/O device 120 may be configured to receive the touch input data that may be performed with a single finger touch input, a multi-finger touch input, a stylus, a palm, a combination thereof, etc. Therefore, the processor 105 may determine whether the finger use input is a “one-finger” touch input, a “two-finger” touch input, etc. For example, when the finger use input indicates that a one-finger touch input is used, the commands associated with the application in use and the one-finger touch input are determined. In another example, when the finger use input indicates that a two-finger touch input is used, the commands associated with the application in use and the two finger touch input are determined. Accordingly, an initial mapping on the gesture library 200 may be performed. If the finger use input is not be determined (step 315) or after the actions for the respective finger use input are determined (step 320), the method 300 continues to step 325.

In step 325, the processor 105 determines whether the pressure input is to be determined. Substantially similar to the finger use input, the application in use may indicate that the pressure input is used or not used in the gesture library. If the pressure input is to be determined, the method 300 continues to step 330. In step 330, an amount of pressure of the touch input data is determined so that the actions for the respective pressure input are determined. Specifically, the processor 105 determines the force input associated with the touch input data. As discussed above, the I/O device 120 may be configured to include a force sensor to determine the type of pressure of the force input. Therefore, the processor 105 determines, for example, whether the force input is a low or a high pressure one. For example, when the force input indicates that a low pressure is used, the commands associated with the application in use and the lower pressure input are determined. In another example, when the force input indicates that a high pressure is used, the commands associated with the application in use and the pressure input are determined. Furthermore, if the finger use input is determined in step 320, the mapping of the command may further be determined as a function of the application in use, the finger use input, and the pressure input. Accordingly, a further mapping on the gesture library 200 may be performed. If the pressure input is not be determined (step 325) or after the actions for the respective pressure input are determined (step 330), the method 300 continues to step 335.

In step 335, the processor 105 determines whether the location input is to be determined. Substantially similar to the finger use input, the application in use may indicate that the location input is used or not used in the gesture library. If the location input is to be determined, the method 300 continues to step 340. In step 340, the position on the I/O device 120 in which the touch input is received is determined so that the actions for the respective location input are determined. Specifically, the processor 105 determines the location input associated with the touch input data. As discussed above, the I/O device 120 may be configured to receive the touch input data anywhere on a surface of the I/O device 120, at predetermined areas of the I/O device 120, etc. Therefore, the processor 105 determines, for example, whether the location input is on a top area of the I/O device 120, a bottom area of the I/O device 120, a left area of the I/O device 120, a right area of the I/O device 120, a middle area of the I/O device 120, etc. For example, when the location input indicates that a top area of the I/O device 120 is used, the commands associated with the application in use and the location input at the top area are determined. In another example, when the location input indicates that a bottom area of the I/O device 120 is used, the commands associated with the application in use and the location input at the bottom area are determined. Furthermore, if the finger use input, the pressure input, or both are determined in step 320/330, the mapping of the command may further be determined as a function of the application in use, the finger use input/the pressure input, and the location input. Accordingly, a further mapping on the gesture library 200 may be performed. If the location input is not be determined (step 335) or after the actions for the respective location input are determined (step 340), the method 300 continues to step 345.

In step 345, the processor 105 determines whether the gesture input is to be determined. Substantially similar to the finger use input, the application in use may indicate that the gesture input is used or not used in the gesture library. If the gesture input is to be used, the method 300 continues to step 350. In step 350, a gesture of the touch input data is determined. Specifically, the processor 105 determines the gesture input associated with the touch input data. As discussed above, the I/O device 120 may be configured to determine changes in locations over time of the touch input data from an initial disposition to a final disposition to determine whether the gesture data is certain type of motion (e.g., a motion from left to right, a motion from right to left, a back and forth motion, a diagonal motion, etc.). For example, when the gesture input indicates that a left to right motion is used, the commands associated with the application in use and the left to right gesture input are determined. In another example, when the gesture input indicates that a diagonal motion is used, the commands associated with the application in use and the diagonal gesture input are determined. Furthermore, if the finger use input, the pressure input, the location input, or any combination thereof are determined in steps 320/330/340, the mapping of the command may further be determined as a function of the application in use, the finger use input/the pressure input/the location input, and the gesture input. Accordingly, a further mapping on the gesture library 200 may be performed. If the gesture input is not be determined (step 345) or after the actions for the respective gesture input are determined (step 350), the method 300 continues to step 355.

In step 355, from the above described determinations, the command to be performed may be determined from mapping the action on the gesture library. Accordingly, in step 360, the mapped action may be performed.

It should be noted that the method 300 is only exemplary. The determination and the order of the mapping to determine the command may be performed using a variety of different sequences. As discussed above, a different sequence may entail the determination of the application in use to be performed as the final step after the touch input data has been mapped on the gesture library 200. In another example, the force input or the gesture input may be determined initially. Accordingly, regardless of the sequence in which the finger use input, the force input, the gesture input, and the application in use are determined, the mapping to the gesture library 200 to determine the command may be performed in which the command satisfies the conditions of the aforementioned inputs and correspond to the application in use.

As illustrated in the method 300, any number of parameters of the touch input may be used to determine the command to be performed. That is, using the application in use parameter, any number of factors of the touch input may be used to determine the command to be performed. For example, the touch input may include the finger use input, the force input, the gesture input, and the location input. At least one of these factors of the touch input may indicate the command to be performed. Thus, with a given application in use, only the finger use input and the force input may be required or used to determine the command. In another example, all four aspects of the touch input may be used, three of the four aspects may be used, etc. Accordingly, at least one of the steps 315, 325, 335, and 345 may include a positive determination for using the particular input parameter of the touch input.

The exemplary embodiments of the present invention provide a multi-modal means of enabling a common gesture to be used for a variety of commands. An electronic device may be configured to receive a touch input data that includes at least one of a finger use input, a force input, a gesture input, and a location input. As a function of a single or combination of these inputs and to an application in use, a predetermined command that is mapped on a gesture library may be executed. The finger use input may relate to the manner in which the touch input data is entered. Thus, the finger use input may be a single finger touch input, a two finger touch input, a stylus input, a palm input, a combination thereof, etc. The force input may relate to a pressure being applied when the touch input data is entered. Thus, the force input may be a low pressure, a mid pressure, or a high pressure. The gesture input may relate to a motion from an initial disposition to a final disposition on the I/O device over a period of time. Thus, the gesture input may be a motion from left to right, a motion from right to left, a separating motion for a multi-finger touch input, a closing motion for a multi-finger touch input, an arc-type motion, an angled motion, a diagonal motion, any combination thereof, etc. The location input may relate to a position on the I/O device that the touch input is received. Thus, the location input may be on a top area, a bottom area, a right area, a left area, etc. of the I/O device. Using any combination of the above types of inputs for the touch input data and mapping these combinations for each application in use, specific commands may be performed.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
determining an application-in-use data, the application-in-use data indicative of an application being executed by a processor on an electronic device;
receiving, by a touch sensitive input device of the electronic device, a touch input data including at least one of a finger use input data, a force input data, a gesture input data, and a location input data, the finger use input data indicative of a manner in which the touch input data is entered, the force input data indicative of a pressure applied in how the touch input data is entered, the gesture input data indicative of a motion included in the touch input data over time, the location input data indicative of a position on the touch sensitive input device the touch input is received; and
determining a command to be executed as a function of the application-in-use data and at least one of the finger use input data, the force input data, the gesture input data, and the location input data.

2. The method of claim 1, wherein the manner of the finger use input data is one of a one finger touch input, a multi-finger touch input, a stylus input, a palm input, and a combination thereof.

3. The method of claim 1, wherein the pressure of the force input data is one of a low pressure, a middle pressure, and a high pressure, wherein the low pressure has a first range of areas of contact, the middle pressure has a second range of areas of contact greater than the first range, the high pressure has a third range of areas of contact greater than the second range.

4. The method of claim 1, wherein the motion of the gesture input data is one of a left-to-right motion, a right-to-left motion, a back-and-forth motion, an arc-type motion, an angled-type motion, a diagonal motion, and a combination thereof.

5. The method of claim 1, wherein each combination of the finger use input data, the force input data, the gesture input data, and the location input data applicable to the application-in-use data are stored in a gesture library.

6. The method of claim 5, wherein the determining the command step comprises:
determining a first plurality of commands associated with the finger use input data, the first commands being a subset of the combinations for the application-in-use data;
determining a second plurality of commands associated with the force input data, the second commands being a subset of the first commands;
determining a third plurality of commands associated with the location input data, the third commands being a subset of the second commands; and
determining the command associated with the gesture input data, the command being one of the third commands.

7. The method of claim 1, wherein the touch sensitive input device includes a force sensor configured to determine a plurality of granularities associated with the touch input data.

8. The method of claim 7, wherein a predetermined range of granularities is indicative of the force input data as a function of the finger use input data.

9. The method of claim 1, wherein the application in use data defines predetermined regions on the touch sensitive input device for receiving the touch input data.

10. A device, comprising:
a processor configured to execute an application; and
a touch sensitive input device configured to receive a touch input data including at least one of a finger use input data, a force input data, a gesture input data, and a location input data, the finger use input data being indicative of a manner in which the touch input data is entered, the force input data being indicative of a pressure applied in how the touch input data is entered, the gesture input data being indicative of a motion included in the touch input data over time, the location input data indicative of a position on the touch sensitive input device the touch input is received,
wherein the processor is configured to determine an application-in-use data as a function of the application being executed,
wherein the processor is configured to determine a command to be executed as a function of the application-in-use data and at least one of the finger use input data, the force input data, the gesture input data, and the location input data.

11. The device of claim 10, wherein the manner of the finger use input data is one of a one finger touch input, a two finger touch input, a stylus input, and a palm input, and a combination thereof.

12. The device of claim 10, wherein the pressure of the force input data is one of a low pressure, a middle pressure, and a high pressure, wherein the low pressure has a first range of areas of contact, the middle pressure has a second range of areas of contact greater than the first range, the high pressure has a third range of areas of contact greater than the second range.

13. The device of claim 10, wherein the motion of the gesture input data is one of a left-to-right motion, a right-to-left motion, a back-and-forth motion, an arc-type motion, an angled-type motion, a diagonal motion, and a combination thereof.

14. The device of claim 10, further comprising:
a memory arrangement storing a gesture library including each combination of the finger use input data, the force input data, the gesture input data, and the location input data applicable to the application-in-use data.

15. The device of claim 14, wherein the processor is further configured to:
determine a first plurality of commands associated with the finger use input data, the first commands being a subset of the combinations for the application-in-use data;
determine a second plurality of commands associated with the force input data, the second commands being a subset of the first commands;
determine a third plurality of commands associated with the location input data, the third commands being a subset of the second commands; and
determine the command associated with the gesture input data, the command being one of the third commands.

16. The device of claim 10, wherein the touch sensitive input device includes a force sensor configured to determine a plurality of granularities associated with the touch input data.

17. The device of claim 16, wherein a predetermined range of granularities is indicative of the force input data as a function of the finger use input data.

18. The device of claim 1, wherein the application in use data defines predetermined regions on the touch sensitive input device for receiving the touch input data.

19. The device of claim 10, wherein the touch sensitive input device is one of an incorporated input/output (I/O) device with a display device, a separate I/O device disposed on a periphery of a housing of the device, and a transparent, multi-touch force sensor disposed over the display device.

20. A computer readable storage medium including a set of instructions executable by a processor, the set of instructions operable to:
determine an application-in-use data, the application-in-use data indicative of an application being executed by a processor on an electronic device;
receive, by a touch sensitive input device of the electronic device, a touch input data including at least one of a finger use input data, a force input data, a gesture input data, and a location input data, the finger use input data indicative of a manner in which the touch input data is entered, the force input data indicative of a pressure applied in how the touch input data is entered, the gesture input data indicative of a motion included in the touch input data over time, the location input data indicative of a position on the touch sensitive input device the touch input is received; and
determine a command to be executed as a function of the application-in-use data and at least one of the finger use input data, the force input data, the gesture input data, and the location input data.
